(19) United States
(12) Patent Application Publication
(10) Pub. No.: US 2026/0166939 A1
(43) Pub. Date: Jun. 18, 2026

(54) ATTENUATING A POTHOLE EFFECT

(71) Applicant: Ford Global Technologies, LLC, Dearborn, MI (US)

(72) Inventors: Cyril COERMAN, Leverkusen (DE); Uwe HOFFMANN, Leverkusen (DE); Peter GILLESSEN, Meuspath (DE); Marcus KALABIS, Krefeld (DE)

(21) Appl. No.: 19/424,425

(22) Filed: Dec. 18, 2025

(30) Foreign Application Priority Data
Dec. 18, 2024 (DE) 102024138612.6

(51) Int. Cl. B60G 17/0165

(52) U.S. Cl. CPC B60G 17/0165; B60G 2400/0511; B60G 2400/0512; B60G 2400/102; B60G 2400/104; B60G 2400/106; B60G 2400/204; B60G 2400/208; B60G 2400/252; B60G 2400/821; B60G 2401/14; B60G 2500/10

(57) ABSTRACT

A method for controlling a force, in an open loop, between wheels and a vehicle body including front and rear axles when overcoming a roadway depression. A suspension means includes at least one arrangement of a spring system and a vibration damper having at least one actuating member for controlling damper forces in a closed loop. The method includes detecting a roadway profile ahead where depressions in the roadway are detected prior to or when reached by the vehicle, adding a detected depression in the roadway as an event to an event queue, selecting the depression in the roadway that is the next event in the event queue, adjusting the suspension means to a suitable setting in order to overcome the depression in the roadway when the detected depression in the roadway has been verified, or ending the method when the detected depression in the roadway has not been verified.

### TECHNICAL FIELD

Example embodiments generally relate to a method for controlling forces between wheels and body of a vehicle when overcoming a depression in a roadway and to a vehicle for carrying out the method.

### BACKGROUND

Modern vehicles frequently include active, semi- and/or adaptive suspension systems of the wheels in order to control, in particular, vertical movements of the wheels in an open loop. The aim in this case is to significantly reduce in particular vertical oscillations which can occur when a depression in the roadway is passed through. The chassis forces are selectively adapted to abnormal states of the roadway in four quadrants of the vehicle. An adaptive suspension system is, for example, the Continuously Controlled Damping (CCD) from FORD, to which reference is made, for example, in the generic document DE 10 2022 100 005 A1.

When a relative movement occurs between a wheel of a vehicle and the corresponding roadway surface, changes occur in the transmission of force from the wheel onto the roadway, which can cause reduced road grip. A resulting vertical vibratory movement is also referred to as vertical wheel oscillation. Vertical wheel oscillations occur more frequently, for example, when driving over depressions in the roadway, for example, potholes. Roadways are, in this case, for example, streets containing asphalt or concrete, but also cobblestone roads, country lanes, inter alia.

Active oscillation actuators enable a more efficient response to depressions in the roadway, by controlling the chassis forces in the suspension means of all wheels in a closed loop, than passive vibration dampers, which dampen vertical vibratory movement of the wheel and of the vehicle body, but cannot respond to depressions in the roadway. Damping control systems, which are directed, in particular, to the comfort of the vehicle occupants, for example, the CCD, can respond to depressions in the roadway only to a limited extent, wherein the wheel is prevented from dropping into the depression by adjusting the damping to be softer, wherein the required damping force depends on the absolute vertical speed of the vehicle body. By means of an active chassis, a pothole detected in advance can even be jumped over.

By means of a camera, the presence and the dimensions of a depression in a roadway, in particular of a pothole, can be detected. Camera data can deliver false-positive information regarding a pothole, however, i.e. a pothole is reported even though a pothole is not actually present, but rather, for example, only a dark spot in the pavement, which differs from lighter surroundings. If settings of the dampers are changed on the basis of the false-positive information, this can result in an impairment of the road holding of the vehicle, and thus in turn also in a reduction of the ride comfort. The object may be to verify sensor information from different sources to overcome depressions in the roadway and to actuate an active suspension means accordingly.

### BRIEF SUMMARY OF SOME EXAMPLES

A method for controlling at least one force, in an open loop, between the wheels and the vehicle body of a vehicle including at least one front axle and one rear axle when overcoming at least one roadway depression in the roadway may be provided. A suspension means of each wheel may includes at least one arrangement of a spring system and a vibration damper having at least one actuating member for controlling damper forces in a closed loop. The method may include detecting a roadway profile lying ahead in the direction of travel, wherein depressions in the roadway are detected prior to being reached by the vehicle and/or when reached by the vehicle. The method may further include adding a detected depression in the roadway as an event to an event queue, selecting the depression in the roadway that is the next event in the event queue, adjusting the suspension means to a suitable setting in order to overcome the depression in the roadway when the detected depression in the roadway has been verified, or ending the method when the detected depression in the roadway has not been verified.

By employing the method, a best possible ride comfort for occupants of the vehicle may be advantageously provided. In the method according to example embodiments, two algorithms may be implemented. The first algorithm relates to detecting a depression in the roadway. The second algorithm relates to an open-loop control of overcoming the depression in the roadway, wherein a check is carried out at the beginning of the second algorithm to determine whether the depression in the roadway actually exists. If it is determined that a depression in the roadway has been detected in a false-positive manner, i.e. is not present, the control algorithm can be aborted in order to minimize a negative effect on the ride comfort.

Depressions in the roadway are negative shapes of the roadway profile. Depressions in the roadway are, in the context of the present invention, in particular potholes; the terms depression in the roadway and pothole are used synonymously here. A pothole is defined in this description as a depression in the roadway having a length between 0.3 m and 2 m and a depth between 3 cm and 10 cm. Correspondingly dimensioned potholes are frequently used on proving grounds in vehicle development. The software on which the method according to the invention is based was developed on the basis of a vehicle model in which six passengers sit and the suspension means has a maximum power of 6 kW and a maximum force of 12 kN. The method is also suitable for smaller actuators and was also tested as such.

In some cases, depressions in the roadway are detected prior to being reached by the vehicle by means of at least one camera on the vehicle and/or a highly accurate map, and depressions in the roadway are detected when reached by the vehicle by means of chassis height sensors of the front wheels of the vehicle and/or an artificial neural network. In other words, a camera is used, when it is available, to detect a depression in the roadway prior to it being reached by the vehicle. If a camera is not available, for example, due to a malfunction or if the vehicle does not have a camera, depressions in the roadway are not detected in advance with respect to the front wheels, but rather immediately when reached, by the chassis height sensors of the front wheels. In this case, the detection of a depression in the roadway can be assisted by using a highly accurate map. For the rear wheels, the suspension means can be adjusted predictively on the basis of the information regarding the depression in the roadway obtained via the front wheels. Depressions in the roadway are therefore preferably detected in a preview mode of the wheels on the front axle when a camera is available, and in a blind mode of the wheels on the front axle when a camera is not available.

A corresponding camera is designed to detect depressions approximately 5 m to 15 m ahead of the vehicle. Dark spots on the asphalt, also induced by moisture or shadows, can be mistaken for depressions and thus deliver false-positive information. In addition, depressions cannot be detected when the light conditions are not insufficient, or, for example, potholes are filled with water or covered with snow, and thus deliver false-negative information. In this case, previous information regarding the route can be used.

The use of a highly accurate map is also referred to as geofencing. Geofencing is familiar to a person skilled in the art; geofencing registers the crossing of a certain geolocated boundary on the roadway that corresponds to the depression in the roadway or to a certain distance ahead of the depression in the roadway. This position detection can be carried out, for example, by means of a mobile communications device or a navigation device located aboard the vehicle.

The steps for detecting a depression in the roadway are carried out simultaneously as substeps of the method. The difference between the detection and the verification is that the detection is carried out immediately, i.e. as quickly as possible, because any time delay would have a great negative influence on the comfort. The verification does not need to be carried out as quickly, since the influence of the verification on the comfort is not so serious.

As explained above, depressions in the roadway are detected either in a preview mode or in a blind mode. In the blind mode, a pothole that was not previously detected by a camera is detected at the front wheel. The pothole is therefore detected because the wheel has already dropped into the pothole. In the preview mode, information regarding the distance to a pothole and the pothole length is known in advance, i.e. in particular for the front wheels, when the pothole was detected using a camera, and for the rear wheels on the basis of the information obtained via the front wheels. The detections by means of camera, chassis height sensors, and highly accurate maps run independently of one another and simultaneously.

All detected depressions in the roadway are stored in an event queue. For each detected depression in the roadway, two events are added, specifically one event per axle in each case. Preferably, depressions in the roadway are detected in a preview mode when a camera is available; in this case, two preview events are created. Preferably, depressions in the roadway are created in a blind mode of the front wheels and in a preview mode for the rear wheels when a camera is not available.

In some cases, the events in the event queue are sorted in accordance with the distance from the depression in the roadway to the relevant wheel. The wheel that hits the depression in the roadway first is always first in the event queue. In the case of a depression detected by means of the camera, an event is associated with the wheels on the front axle and the rear axle as an event detected in the preview mode, and in the case of a depression in the roadway detected by means of the height sensors, an event is associated with the wheels on the front axle as an event detected in the blind mode and an event is associated with the wheels on the rear axle as an event detected in the preview mode.

In an example embodiment, in the preview mode, a suitable adjustment of the actuators is calculated according to whether the wheel is to be lifted over the depression in the roadway or whether the depression in the roadway is to be passed through. Thus, advantageously, the vertical acceleration of a vehicle wheel traveling through the particular depression in the roadway is significantly reduced as compared to conventional methods.

In an example embodiment, the roadway that is upcoming in the direction of travel of the vehicle is monitored by means of a camera and the information from the camera is checked by means of at least one chassis height sensor. In this strategy of the method according to the invention, when a depression in the roadway is driven over, the information is verified and, optionally, the dimensions of the depression are measured.

In an example embodiment, in the preview mode, a decision is reached depending on the length of the depression in the roadway in the direction of travel and the speed of the vehicle as to whether the wheel that is located ahead of the depression in the roadway will be lifted over the depression in the roadway or will pass through the depression in the roadway, and the crossing is divided into a preview phase, a traversal phase, and a post-traversal phase, wherein the traversal phase is subdivided into at least one first and one second partial phase, and in the first partial phase, a depression in the roadway detected by the camera is verified by means of the chassis height sensor.

In an example embodiment, in the blind mode, the crossing of the depression in the roadway by the front wheels is divided into a traversal phase and a post-traversal phase, wherein the traversal phase is subdivided into at least one first and one second partial phase, wherein, in the first partial phase, the bottom of the depression in the roadway has not yet been reached and a force requirement is sent to the actuators to set the damping to be harder, and in the second partial phase, in which the bottom of the depression in the roadway has been reached, the force requirement is cancelled. For the rear wheels, the above-described sequence applies to the preview mode.

In an example embodiment, the acting forces are balanced over the actuators in the other suspension means when the force requirements exceed the capacity of at least one actuator in a suspension means. Advantageously, the actuators of all wheels of the vehicle are actuated in order to make the movement of the vehicle body as comfortable as possible. Thus, in extreme situations, the acceleration forces acting on the interior space of the vehicle can be counteracted for the sake of increased ride comfort.

GPS data combined with cloud-based data can provide information regarding the length of the depression in the roadway. The beginning of the depression in the roadway is detected in this case by the chassis height sensors. When suspension-means sensors detect the onset of a pothole, the end of the pothole can be inferred by means of cloud data in which information regarding the pothole length is stored.

If a pothole is not detected by the camera, a detection by means of further vehicle sensors is used as fallback support. This fallback support can detect a pothole only once a wheel has already dropped into the pothole and the method is therefore in the blind mode. Advantageously, a real-time capable and robust neural network is used, with which input signals can be monitored such that the subsequent closed-loop control can respond quickly. Preferably, information regarding a road condition and a dynamic driving state of the vehicle is used in the neural network. The corresponding dynamic signals are preferably selected from the group including accelerations in the corners of the vehicle, longitudinal and lateral acceleration of the vehicle, roll rate normalized by the track width, pitch rate normalized by the wheelbase, height of drop of the wheel, time curve of vertical and horizontal acceleration, torque, braking torque, wheel speed, vehicle speed, height and acceleration of the suspension means in relation to the movement rate of the vehicle body, and an actuator force. Advantageously, acceleration patterns in all degrees of freedom over a time curve are thus incorporated into the algorithm in order to further improve the accuracy of the measured values obtained using the height sensors of the suspension means. Moreover, torques and braking torques make it possible to determine whether movements are induced by the driver or by the condition of the roadway surface. Parametric modeling facilitates implementation in other types of vehicles.

In an example embodiment, a probability of having hit a depression in the roadway is calculated in the method for each individual front wheel. Probability values are therefore calculated for the left front wheel and for the right front wheel. If the current probability value is greater than a threshold value, a marker is preferably set for the particular front wheel. If the current probability value is greater than the maximum value of a range of probabilities, a marker is not set for the particular front wheel.

In an example embodiment, an effect of the depression is attenuated in the blind mode on the basis of the probability and the marker. In other words, the marker and the individual probabilities are used to attenuate the effect of the impact. The actuator preferably acts with the greatest possible force in order to retract the wheel until the actual presence of a depression in the roadway is verified. In other words, the actuator preferably acts with the greatest possible force in order to retract the wheel until the marker is set. Thus, time is advantageously gained in the area of the region of the pothole reached first by the vehicle, and the negative side effects of making adjustments to the actuating members that would not have been necessary are avoided. The ride comfort is advantageously increased as a result.

A second aspect of example embodiments relates to a vehicle for carrying out a method according to the invention, which vehicle has a control device designed for the open-loop control of the method. The advantages of the vehicle correspond to the advantages of the method according to the invention.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a schematic representation of an embodiment of a vehicle according to an example embodiment;

FIG. 2 shows a view of the vehicle with a legend for designating the wheels of the vehicle according to an example embodiment;

FIG. 3 shows a schematic representation of a vehicle wheel approaching a depression in the roadway according to an example embodiment;

FIG. 4 shows a schematic representation of individual phases when a depression in the roadway is passed through in a blind mode according to an example embodiment;

FIG. 5 shows a schematic representation of the phases when a wheel is lifted over the depression in the roadway in a preview mode according to an example embodiment;

FIG. 6 shows a schematic representation of the phases when the depression in the roadway is passed through in the preview mode according to an example embodiment;

FIG. 7 shows a pictorial representation of a vehicle on a roadway with a depression in the roadway according to an example embodiment;

FIG. 8 shows a pictorial representation of a vehicle on a roadway with multiple depressions in the roadway according to an example embodiment;

FIG. 9 shows a flowchart of an embodiment of a method according to an example embodiment;

FIG. 10 shows a subdivision of a step of the method according to FIG. 9 according to an example embodiment;

FIG. 11 shows a subdivision of a further step of the method according to FIG. 9 according to an example embodiment;

FIG. 12 shows a representation of an event queue according to an example embodiment;

FIG. 13 shows a subdivision of a further step of the method according to FIG. 9 according to an example embodiment;

FIG. 14 shows a subdivision of a further step of the method according to FIG. 9 according to an example embodiment;

FIG. 15 shows a tabular representation of results of calculations of the power management according to an example embodiment;

FIG. 16 shows a diagram for comparing algorithms for passing through potholes as a function of the length of the pothole according to an example embodiment; and

FIG. 17 shows a diagram of simulated passes through potholes as a function of the size of the shock absorber according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other. It should be noted that the features and measures presented individually in the following description can be combined in any technically feasible manner, giving rise to further embodiments of the invention. The description additionally characterizes and specifies aspects of some example embodiments, particularly in conjunction with the figures. It should be noted that the features and measures mentioned individually in the following description can be combined with one another in any technically expedient manner and reveal further embodiments of the invention. The description additionally characterizes and specifies the invention in particular in conjunction with the figures. The terms “first”, “second”, etc. used in this description serve merely for the purpose of distinction. In particular, the use of these terms is not to imply any order or priority of the elements or objects mentioned in connection therewith.

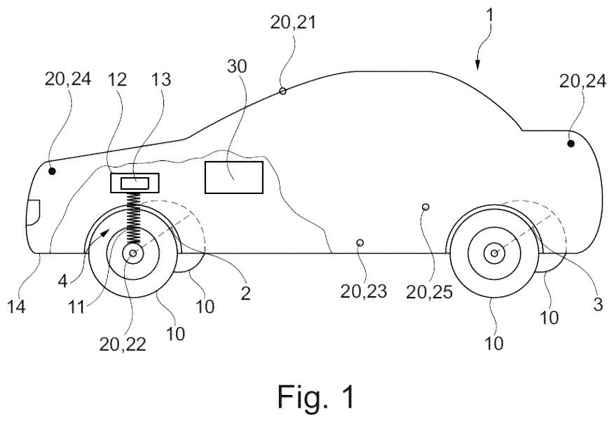

An embodiment of a vehicle 1 according to the invention according to the representation from FIG. 1 has a front axle 2 and a rear axle 3, at each of which two wheels 10 are arranged (front left, front right, rear left, and rear right) via suspension means 4. The vehicle 1 is shown in a cut view in the region of the left front wheel in order to show the arrangement of the wheel 10 with the suspension means 4 by way of example.

The suspension means 4 has in each case inter alia a spring system 11 and a vibration damper 12. An actuating member 13 is arranged in the vibration damper 12. The actuating member 13 can be moved to dampen and to apply active forces. It is clear that the vibration damper 12 consists of multiple elements and can also have multiple actuating members and actuators which are not represented here for the sake of clarity. The suspension means can be an active suspension means or a semi-active suspension means and/or include actively controlled stabilizers. An active actuator adjusts forces between the wheel and the body.

The vehicle 1 has a number of different sensors 20. A camera 21 is arranged pointing forward such that an upcoming roadway can be observed. In addition, at least one chassis height sensor 22 is arranged in the suspension means 20 and is also connected to the control device 30. The chassis height sensor 22 is designed to detect a change in the bounce height and thus is particularly well suited to measure the change in height of the relevant wheel 10 when passing an abnormality in a roadway, in particular a depression. A further sensor 20 is a sensor for measuring the vertical acceleration 23, which sensor is arranged in the center of gravity of the vehicle 1. Acceleration sensors 24 can also be arranged in the top mounts in the corners of the vehicle 1. The vehicle 1 also has at least one pitch rate sensor 25. Further possible sensors that the vehicle 1 can have are based on ultrasound, radar, LiDAR, laser, and other technologies.

The sensors 20 are connected to a control device 30. The control device 30 is designed to evaluate the data transmitted from the sensor(s) 20 and to transmit corresponding control commands to the actuators of the particular actuating member 13.

The vehicle 1 is also designed for vehicle-to-vehicle communication. In addition, the vehicle 1 is designed to contact a satellite-based device for geofencing and to collect corresponding data.

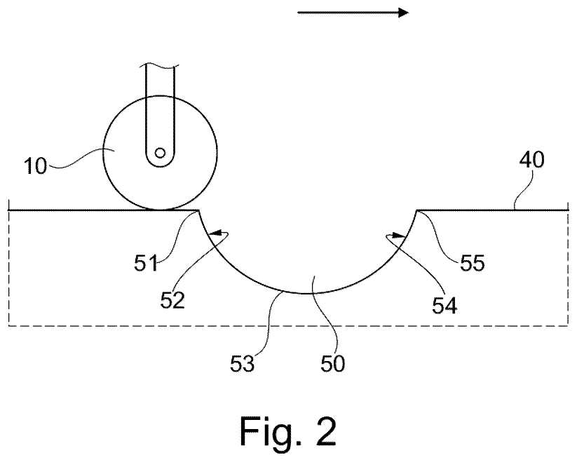

The situation of the vehicle 1 on a roadway 40 is represented in FIG. 2. The roadway 40 is an asphalted road in this case, by way of example. The vehicle 1 moves in a certain direction, for example in the forward direction, as indicated by the arrow. A depression in the roadway, which is synonymously referred to as a pothole 50 as described above, is present in the roadway 40. The pothole 50 begins with a proximal edge 51, which the wheel 10 reaches first. From the proximal edge 51, a descending flank 52 extends to a bottom 53 of the pothole 50. From the bottom 53, an ascending flank 54 extends to a distal edge 55 of the pothole 50.

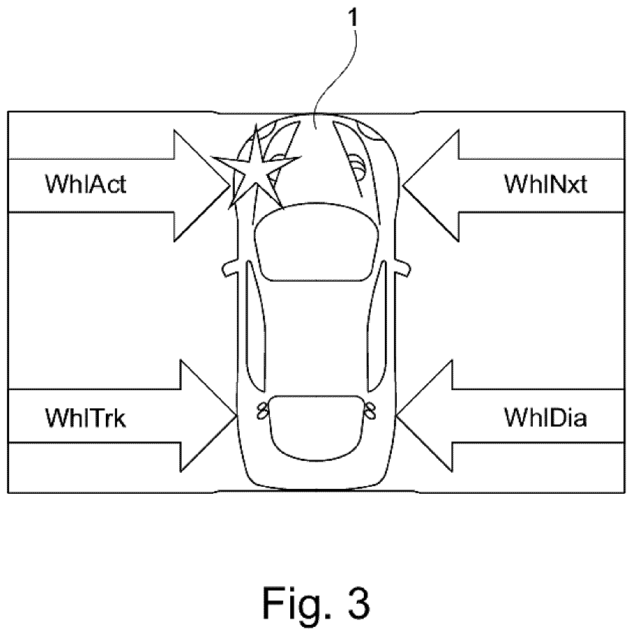

The four wheels 10 are specified in greater detail in the top view according to FIG. 3 with the designations that are suitable for explaining a method according to the invention for crossing a pothole 50. The left front wheel in this case is, by way of example, the wheel that is about to cross or is in the process of crossing a pothole 50, and is also referred to as WhlAct. The right front wheel is also referred to as WhlNxt, i.e. the wheel 10 that is arranged on the same axle as the WhlAct. The left rear wheel is also referred to as WhlTrk, i.e. the wheel 10 that is located in the same track as the WhlAct. The right rear wheel is also referred to as WhlDia, i.e. the wheel 10 that is located diagonally opposite the WhlAct.

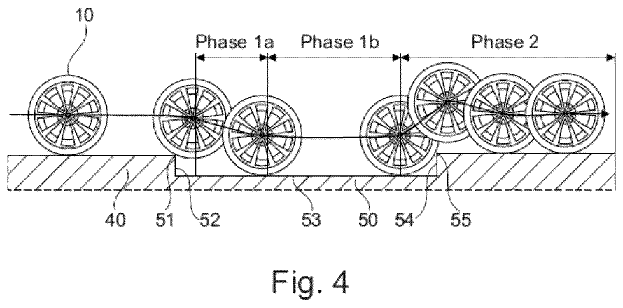

Overcoming a pothole 50 is explained with reference to FIGS. 4 through 6. In the preview mode, the distance to the rim of a detected pothole and its length are known. In the blind mode, no advance information regarding the pothole is known.

Overcoming a pothole 50 can be subdivided, in principle, into three phases:

Phase 0: a preparatory phase, which relates to the situation of a wheel prior to reaching the pothole. This relates only to a pothole that was detected in the preview mode.

Phase 1: a traversal phase, which relates to the situation of a wheel in or over the pothole.

Phase 2: a post-traversal phase, which relates to the situation of a wheel once the end of the pothole has been reached, until the corresponding vehicle travels smoothly again.

In the blind mode (FIG. 4), when a pothole has been detected by means of one or more height sensors, the length of the pothole is unknown when the pothole is reached. Since this information is essential, however, phase 1 is subdivided into two partial phases:

Phase 1a: relates to the situation of a wheel in a pothole that has been detected, wherein the bottom of the pothole has not yet been reached.

Phase 1b: relates to the situation of a wheel in a pothole, the bottom of which has been reached, wherein the ascending end of the pothole has not yet been reached.

In order to subdivide overcoming the pothole 50 into two phases, it must be possible to differentiate hitting the pothole bottom 53 from hitting the distal edge 55 of the pothole 50. In phase 1a there are two tasks. The first task is directed towards avoiding the situation in which the corresponding wheel (WhlAct) drops too far into the pothole 50 by pulling the wheel WhlAct upwards by means of a preset force profile of the actuators in the suspension means 12. The task is solved by adjusting the actuating member 13 to a hard setting. The less the wheel WhlAct drops into the pothole 50, the lesser is the effect when it reaches the ascending end of the pothole 50. It is important that the force not be selected to be too great, such that a sufficient movement of the suspension means 12 is still ensured if the pothole 50 is longer and reaching the bottom 53 cannot be avoided. The wheels WhlNxt and WhlTrk are pushed upwards in order to counteract the negative acceleration and to hold the vehicle up. The inclination is controlled via differential forces. The wheel WhlDia is actuated to control the rolling movement.

The second task is directed towards preventing the vehicle 1 from dropping too far into a pothole 50 by pushing the vehicle body upwards, wherein the negative acceleration, which pushes the vehicle 1 into the pothole 50, is reduced. The wheels WhlNxt and WhlTrk are used to control the vertical acceleration and the pitch acceleration of the vehicle 1 partially by means of proactively acting control commands, into the calculation of which, for adjusting the force of the actuators, the ADD (Acceleration Driven Damping) control for pulling and pushing the wheels 10 and the vehicle 1 is incorporated. The wheel WhlDia is used to control the rolling of the vehicle 1, as a result of which a pulling force is generated.

When the phase 1b is reached, this indicates a longer dimension of the pothole 50. The wheel WhlAct has dropped into the pothole and has reached the bottom of the pothole 50. The force requirement on WhlAct is reversed (i.e. from pulling to pushing) in order to maintain the spring deflection. Thus, the vehicle body is to be held up and the suspension-means height of WhlAct is restored as quickly as possible once the wheel has reached the bottom. The wheels WhlNxt and WhlTrk are pushed upwards in order to counteract rather negative acceleration and to hold the vehicle body up. All wheels are used to control the lifting and tilting of the vehicle.

When all four wheels 10 of the vehicle 1 have reached a level road bed again, the normal ADD control can be used to control the lifting and pushing-away of the wheels 10, wherein the values of each corner of the vehicle are used individually. The lifting is controlled in an open loop solely by the wheels WhlNxt and WhlTrk, wherein a precontrol of a force requirement is additionally used to ensure that the vehicle 1 is pushed upwards. Thus, the situation is avoided in which WhlDia rebounds by too great of an extent and more weight is pressed on WhlAct.

In phase 2 (post-traversal phase), the damping is used to divert energy from the system in order to control the movement of the vehicle 1. The post-traversal phase can also be used as phase 0 for a subsequent pothole 50. This means that the preparatory forces for the subsequent pothole 50 are added to the force requirements for each corner of the vehicle. For WhlAct, the initial damping during the first suspension cycle is reduced after the impact. The pushing forces at WhlNxt and WhlTrk are reduced.

Once the ascending end has been reached, phase 2 begins, in which the vehicle 1 reaches the roadway 40 again and the position of the vehicle 1 is controlled.

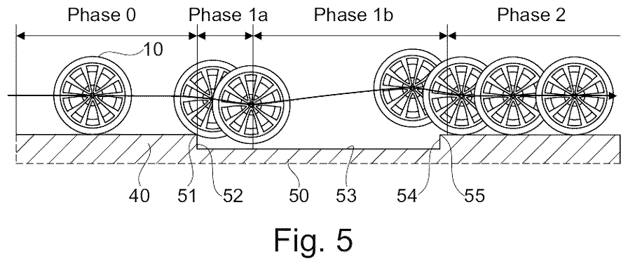

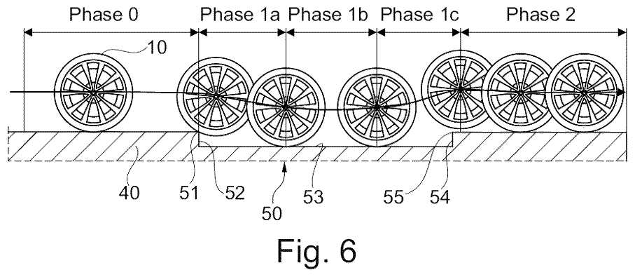

In the preview mode, two sub-algorithms are used; specifically, one to lift the wheel 10 over the entire pothole 50 (FIG. 5) and the other to drive the wheel 10 on the bottom of the pothole 53 and then lift it over the distal edge 55 of the pothole 50 (FIG. 6). Which of the sub-algorithms is selected depends on the following factors:

First, the expected duration required to overcome the pothole 50, which depends on the current speed of the vehicle 1 and the length of the pothole 50. This is the main factor that is used in the decision whether to lift a wheel 10 over the pothole 50 and whether to pass through the pothole 50. The resulting duration that it calculates is the duration that the wheel 10 hangs freely prior to hitting the bottom 53. The duration that the wheel 10 may hang freely until a decision is reached is established to be 0.12 s (by way of example, since the duration depends on the vehicle). Exemplary values for this are compiled in Table 1, in which the duration is presented as a function of pothole lengths (in m) and vehicle speed (in km/h).

Second, the braking status of the vehicle 1 is used. If braking is underway, the pothole 50 is passed through. The decision is based on the fact that drivers of a vehicle tend to apply the brakes when they discover a pothole 50.

Third, the confidence interval of the camera 21. If it is below a threshold value, the pothole 50 is passed through. This decision is less disturbing to the ride comfort if a false-positive signal is detected. The confidence interval of the camera 21 is therefore incorporated into the selection of the sub-algorithm in order to counteract the negative influence of false-positive camera data.

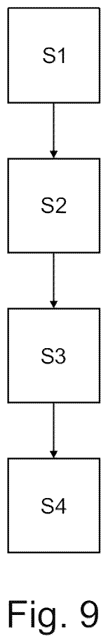

For shorter durations, the sub-algorithm to lift the wheel 10 over the pothole 50 is selected (FIG. 5). In this case, the wheel 10 is lifted over the entire pothole 50 without hitting the ascending edge 55 of the pothole 50. For this purpose, it is essential that (for a front wheel) a camera signal is confirmed in order to counteract a lifting of the wheel 10 from the roadway 40 for no reason in the case of a false-positive signal. Overcoming a pothole 50 by lifting a wheel 10 over the pothole 50 is broken down into individual phases, which are illustrated in FIG. 9.

In phase 0, the following points should be noted. When a single wheel 10 is to be lifted from the roadway, the corresponding vehicle 1 exhibits a tendency to roll and tilt with the corner of the body in which the relevant wheel 10, i.e., the wheel WhlAct, is located. Whereas this movement is slow at the beginning, its speed can exceed the speed at which the wheel WhlAct is lifted from the bottom 53, as a result of which the wheel WhlAct can rise even higher and negatively influence the adjustments of the suspension means. In order to keep the time-of-flight of the wheel WhlAct as great as possible, preparation is necessary. Before the wheel WhlAct is retracted, it is initially extended, together with the wheels WhlNxt and WhlTrk, while the wheel WhlDia is retracted. It is thus ensured that the height of the body over the wheel WhlAct is as great as possible.

All forces are controlled in a closed loop in order to counteract an excessive jerk, wherein the timing is implemented in such a way that the vehicle 1 still has a certain upwards momentum when the wheel WhlAct is retracted. The phase 0 ends at the proximal edge 51 of the pothole 50. The preparation begins x seconds before the vehicle 1 reaches the distal edge 55 of the pothole 50. X has a high value at low speeds of the vehicle 1 and a lower value when the vehicle 1 has a higher speed. At lower values of x the ramp speed is increased.

The highest time-of-flight is reached when all four wheels 10 are at their greatest actuator capacity. For smaller potholes 50, the forces are reduced in accordance with speed and pothole length.

In phase 1a, the initial flight phase, the forces on the wheel WhlAct are held slightly below a threshold value at which they would suffice to pull the wheel WhlAct up. Thus, the wheel WhlAct can drop into the pothole 50 to a minimal extent. Due to this lesser drop, the algorithm can determine that the pothole 50 is actually there. When the wheel WhlAct does not drop to the expected extent, a false-positive value is reported, i.e. that the pothole 50 does not exist. The pulling-up of the wheel WhlAct is terminated and the settings of the actuators are adjusted to their average values.

In phase 1b, the actual flight phase, the wheel WhlAct is lifted to its target height, which corresponds to the height of the distal edge 55 of the pothole 50. It is important that the flight phase is controlled in an open loop in such a way that it lands at the end of the pothole 50, i.e. on or behind the distal edge 55. This is implemented by means of a PID (proportional-integral-derivative) controller, wherein the integral is used to counteract the spring force and the derivative is used to keep the speed of the suspension means, and thus the energy consumption, low. The control signal is the calculated wheel contact point (height of the roadway 40 at the distal edge 55). The wheel contact point is composed of the height of the distal edge 55 of the pothole 50 and the extent of the tire on the wheel 10. The extent of the tire is brought about in that there is no load on the wheels during the flight phase. For example, the diameter of a tire without load is 2 cm greater than with load. The actual diameter of the tire is insignificant for calculating the wheel contact point, however.

The difference between the height of the proximal edge 51 and the distal edge 55 should be approximately zero, assuming that the street is essentially flat. It is assumed that the wheel 10 is in contact with the roadway 40 when the proximal edge 51 is reached.

During the flight phase, the wheel contact point is defined by the movement of the vehicle body 14 and the suspension system. The movement of the suspension system is determined by means of the chassis height sensors 22 on the suspension means; the movement of the vehicle body 14 must be determined, however. The wheel contact point is calculated as follows:

$$Δ {H}_{C P} = Δ {H}_{T M} + Δ {H}_{S} * {m}_{R S} ,$$

wherein ΔH_{CP} is the difference of the wheel contact point (Height of contact patch), ΔH_{TM} is the difference of the height of the body in the vehicle corner of the WhlAct (Height of top mount), ΔHs is the difference of the height of the suspension means, and m_{RS} is a factor for measured values from at least one sensor. The difference is formed in relation to the initial conditions, i.e. before the wheel lifts off the roadway.

The height of the body 14 is unknown during the flight phase and must be integrated. Since integration over a long time tends to vary, this integration is started at the beginning of the flight phase and is carried out only for the duration of said flight phase. The value ΔH_{TM} is determined by integrating the speed of the body. During the initialization of ΔH_{TM} to −1*(HS)*m_{RS} when the proximal edge 51 of the pothole 50 is reached, wherein HS is the height of the suspension means, the following equation for calculating the contact point height is obtained:

$$Δ {H}_{C P} = Δ {H}_{T M} + {H}_{S} * {m}_{R S} .$$

The speed of the body V_{TM} is calculated as follows:

$${v}_{TM} = {v}_{H B} + track width / 2 * roll rate + wheelbase 2 Cog * pitch rate ,$$

in which v_{HB} is the speed at which the body moves vertically; this is not measured, however—it is determined either by means of a Kalman filter, using a pseudo-integrator, which was obtained in the calculations or by means of the following formula:

$${v}_{b} = {v}_{b} * beta 1 + {A}_{z} * {T}_{s} * beta 2 + {v}_{ds} * beta 3 - sign ( {v}_{b} ) * epsilon ,$$

wherein v_{b} is the speed of the body (body), v_{ds} is the mean damper speed (damper speed), A_{z} is the vertical acceleration in the top mount, Ts is the inverse of the frequency with which the algorithm is implemented, i.e. a measure of the time duration of a step, sign(v_{b})*epsilon reduces the signal drift by continuously setting the signal back to 0, wherein sign(v_{b}) is either −1 or +1, and beta 1 through 3 are correction factors.

Once the wheel contact point has been reached, phase 2 of crossing the pothole 50 has been reached. This continues until the vehicle 1 has reached smooth road holding again.

The algorithm for passing through a pothole 50 is selected when the pothole 50 is too long to lift the wheel 10 over it in a flight phase, i.e. the time-of-flight is over 0.12 s according to Table 1. The wheel 10 is deflected by the bottom 53 of the pothole 50 and then lifted before the distal edge 55 of the pothole 50 is reached (FIG. 6), as a result of which the impact when the wheel 10 hits is reduced or completely avoided, depending on the depth of the pothole 50.

It is essential here to confirm the camera information by verifying that the wheel actually dips into a pothole. Basically the strategy is similar to that in the blind mode, with the exception that there is a phase 0 here for preparing the vehicle 1. In addition, a phase 1c is added, in which the wheel 10 is lifted prior to reaching the distal edge 55. The wheel WhlAct is retracted with the greatest possible force of the actuator at an established time interval prior to reaching the distal edge 55, wherein the wheels WhlNxt and WhlTrk are extended. The wheel WhlDia is actuated for controlling the rolling of the vehicle 1 in a closed loop.

The remaining phases correspond to traveling in the blind mode.

In phase 2, damping is used to divert energy from the system and ADD to the vehicle control. In addition, phase 2 is a phase 0 for preparation for a pothole following in the direction of travel. This means that the preparatory forces for the next pothole are used in the force requirements for each corner of the vehicle.

The situation of overcoming a pothole that is not illustrated further in a figure relates to a use of a highly accurate map (geofencing). A region delimited by geofencing can optionally have only one pothole 50 which is situated in the current direction of travel of the vehicle 1. If the vehicle 1 has reached the location, it is assumed that a detected pothole 50 corresponds to the pothole about which data were obtained. If the pothole 50 is detected by the sensors 20 on the vehicle 1, the algorithm detects that this pothole 50 matches received GPS data, which can originate from a cloud.

The vehicle obtains geofencing data on the vehicle 1, which geofencing data includes information regarding the location and the length of the pothole 50.

Once a pothole 50 has been detected by the chassis height sensors of the suspension means, a method corresponding to passing through a pothole 50 in the preview mode is initiated for the front axle 2, wherein the distance to the pothole has a slightly negative value (which is calculated according to detection duration*vehicle speed), since the wheel WhlAct is already in the pothole, but the length of the pothole 50 is known due to the GPS data. The wheels 10 on the rear axle 3 are actuated in the usual preview mode.

If the vehicle 1 travels around the pothole, a pothole is not detected. The corresponding information is then deleted from the memory in the vehicle when the vehicle exits the region delimited by geofencing.

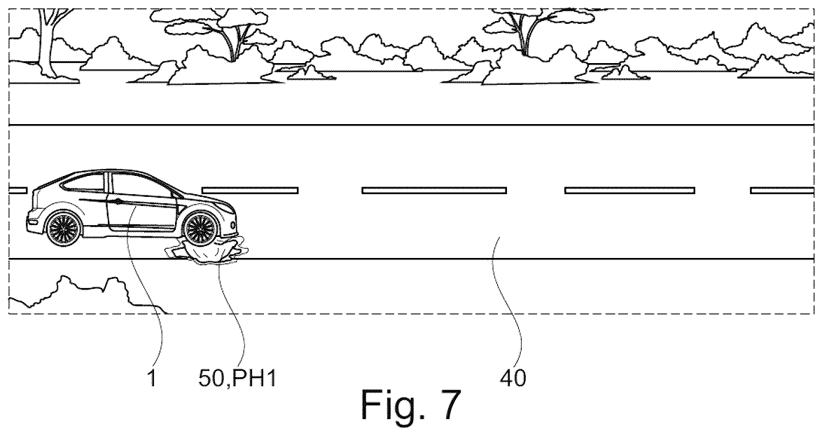

FIG. 7 shows, for this purpose, the situation of a vehicle 1 without the use of a camera on a roadway 40 with a pothole 50 PH1. The right front wheel hits the pothole 50 in the blind mode; the pothole 50 is detected by the chassis height sensor 22 on the right front wheel. Two events are saved in an event queue: the first event relates to the right front wheel currently located over the pothole 50, and the second event relates to the right rear wheel. To adjust the actuators of the right rear wheel, the information from the chassis height sensor 22 (at the beginning and the end of the pothole 50, ergo its length) and regarding the track length (distance between front wheel and rear wheel, i.e. corresponding to the distance until the rear wheel hits the pothole 50) is used (preview mode). The algorithm is axle-based, wherein the phase after a pothole has been overcome is also a phase for preparing for the next pothole. A corresponding event queue is presented in Table 2:

TABLE 2

| Event | | Pothole |
|---|---|---|
| queue | Event | detection |
| 2 | PH1 rear | preview |
| | wheel | mode |
| 1 | PH1 front | blind |
| | wheel | mode |

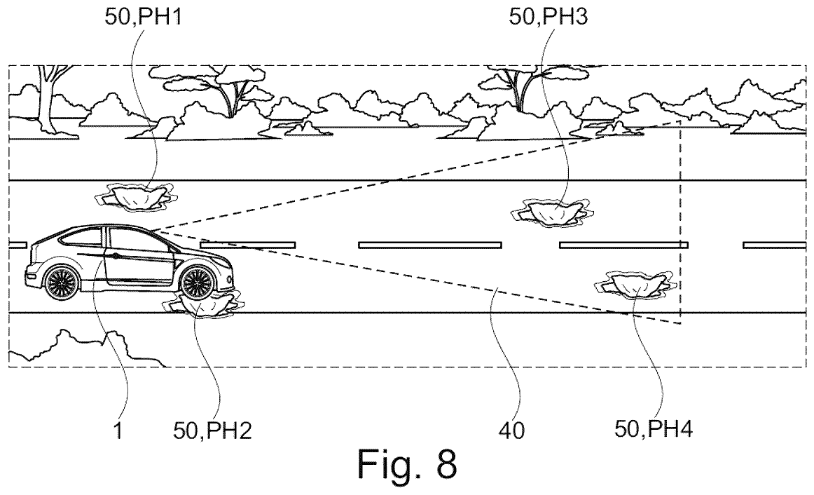

FIG. 8 shows the situation of a vehicle 1 using a camera 21 on a roadway 40 with four potholes 50 (first pothole PH1, second pothole PH2, third pothole PH3, fourth pothole PH4). The field of view of the camera 21 is denoted by dashed lines. The potholes PH1 and PH2 are not detected by the camera, because they are filled with water; these potholes 50 are detected by the chassis height sensors. The pothole PH1 is already located behind the front axle 2, such that, for PH1, only one event related to the rear axle 3 is present in the event queue. The potholes PH3 and PH4 are detected by the camera and later confirmed by the chassis height sensors 22. The distance between the wheels 10 on the front axle 2 and the rear axle 3 are used in the calculation for the preview mode of the wheels 10 on the rear axle 3. Each pothole 50 is associated with two events, which are saved in an event queue. A corresponding event queue is presented in Table 3.

TABLE 3

| Event | | Pothole |
|---|---|---|
| queue | Event | detection |
| 7 | PH4 rear | preview |
| | wheel | mode |
| 6 | PH3 rear | preview |
| | wheel | mode |
| 5 | PH4 front | preview |
| | wheel | mode |
| 4 | PH3 front | preview |
| | wheel | mode |
| 3 | PH2 rear | preview |
| | wheel | mode |
| 2 | PH1 rear | preview |
| | wheel | mode |
| 1 | PH2 front | blind |
| | wheel | mode |

In a method according to FIG. 9 for overcoming a pothole 50 in a roadway 40, in a first step S1, the roadway 40 is monitored for the presence of at least one pothole 50. Potholes 50 are detected by means of sensors, by means of a highly accurate map (geofencing), by means of chassis height sensors, and/or an artificial network (machine learning). Said means are used at the same time.

Threshold values are set for detecting potholes 50. Certain depths of depressions in the roadway and their lengths in the direction of travel are used. The information that a pothole 50 was detected, by means of which of the aforementioned means the pothole 50 was detected, and the distance to the pothole 50 and the length of the pothole 50 is recorded.

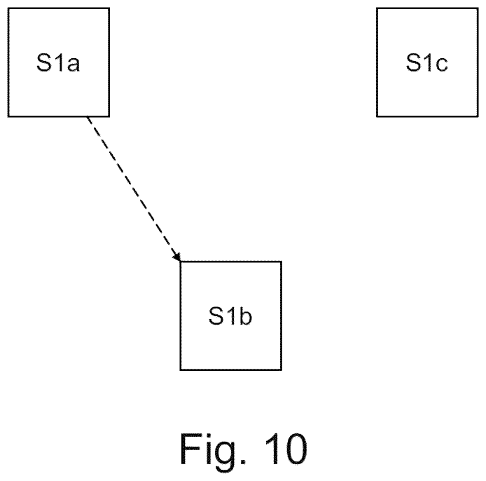

The first step S1 can be subdivided into three substeps, which run at the same time and independently of one another (FIG. 10). In the first substep S1a, a depression is carried out by means of a highly accurate map (geolocation) and cloud information. When a depression in an upcoming route is known, threshold values for the presence of a depression and a corresponding length of the depression can be reduced.

In a second substep S1b, a depression 50 is detected by means of an artificial neural network on the basis of the machine learning algorithm. When a pothole known due to map information is detected in the proximity of the vehicle, a marker is set. This information and the information regarding the pothole length known from the cloud is transmitted from S1a to S1b. Above all, the chassis height sensors on the vehicle are used and, via a time curve, the vertical and horizontal accelerations of the wheels 10 are incorporated into the learning algorithm. A probability that a pothole 50 has been hit is output for the wheels 10 on the front axle 2. A simple logic is implemented here. When the probability of a pothole (P_{PH}) is greater than an upper threshold value on the basis of X continuous samples (SW_{PHup}), i.e. P_{PH}>SW_{PHup}, a pothole marker is set. When the probability of a pothole (P_{PH}) is less than a lower threshold on the basis of Y continuous samples (SW_{PHdown}), the pothole marker is removed, provided one has already been set. Exemplary values for the threshold values are

$$S {W}_{PHup} = 0 \text{.75}$$

$$S {W}_{P H d o w n} = 0.1$$

$$X = 3$$

$$Y = 4.$$

All values are used in calculations to overcome the pothole 50. The actuator forces of the actuating member 13 are ramped up in the blind mode with increasing probability when a probability is (P_{PH}>SW_{PHup}−Z) (e.g. 0.1); Z is a measure of the adjustment when the threshold value has not yet been reached, but is already relatively high, such that the movement of the actuators can be started. The movement can be limited until the presence of a pothole 50 has been actually confirmed. Thus, when overcoming a pothole 10, valuable time can be obtained and side effects of adjusting the actuators on the basis of a false-positive notification of a pothole can be limited. The method carried out by means of a machine learning algorithm is faster than with the typical algorithm.

In a second step S2 within the framework of pothole management, the detected pothole 50 is added as an event to an event queue. Two types of events are differentiated according to how the pothole 50 was detected, namely in the preview mode (by means of a camera) or in the blind mode (by means of chassis height sensors and an artificial network, optionally assisted by geofencing). Every event contains the following information: which wheel 10 (front axle 2 or rear axle 3, left side or right side), distance of the wheel 10 to the pothole 50 (wherein the distance in the preview mode is initially positive and changes over time, and is negative in the blind mode), and the manner in which the pothole 50 was detected.

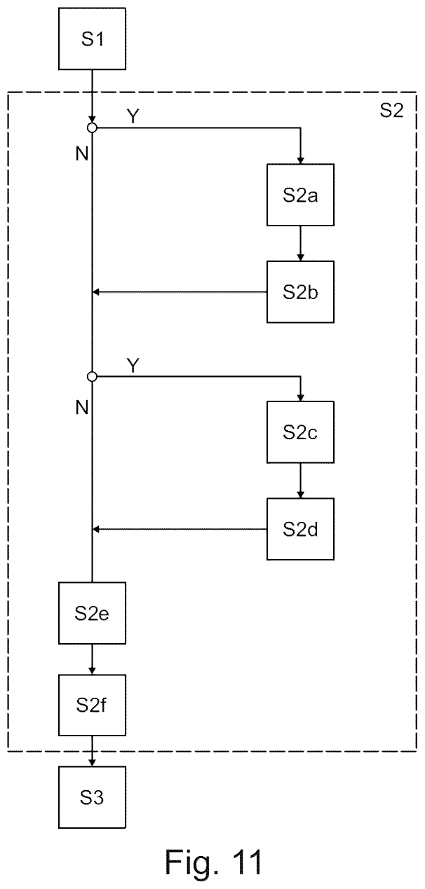

In FIG. 11, the management according to the method step S2 is subdivided into substeps. This is based on the street situation according to FIGS. 7 and 8. In the situation according to FIG. 7 (blind mode for the front axle), in a substep S2a after a pothole 50 PH1 has been detected by means of the chassis height sensors on a wheel on the front axle, S3b_n (b as in blind mode) is added to the event queue as an event.

For the rear axle, in a substep S2b, the pothole PH1 is detected in the preview mode (on the basis of the information regarding the wheel on the front axle) and added to the event queue as event S3p_1 (p for preview) (see Table 2). The distance of the wheel 10 on the rear axle 3 until the pothole 50 is reached is defined as follows:

Distance of the pothole to the rear axle=wheelbase −correction factor,

wherein the correction factor is used because the pothole 50 is detected only when the wheel 10 has already begun to drop into the pothole 50. On the basis of this calculation, it is possible that the rear axle can be actuated in the preview mode using the same algorithm as in the preview mode with the use of a camera 21.

In the situation according to FIG. 8, in which 4 potholes 50 are present in the roadway, in a substep S2c, a pothole 50 PH1 is detected by means of the camera (therefore, preview mode for front axle and rear axle) and added to the event queue as event S3p_2 for the front axle. For the rear axle, in a substep S2d, the pothole PH1 is detected in the preview mode (on the basis of the information regarding the wheel on the front axle) and added to the event queue as event S3p_3. The further potholes PH2, PH3, and PH4 are sorted accordingly (see Table 3).

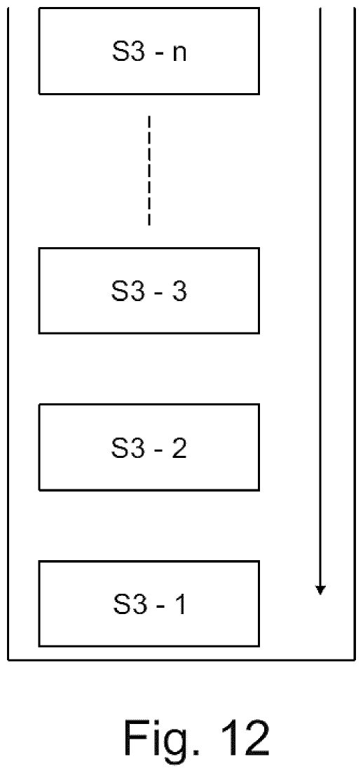

In a substep S2e, the event queue (by way of example in FIG. 12) is sorted. All events in the event queue are and remain active until they are deleted from the event queue. The order in which the events are sorted depends on the distance of the event to a corresponding wheel. Each event corresponds to a wheel on the vehicle crossing a depression and includes the information regarding the presence of a pothole 50, the distance to the pothole 50, and the situation of the pothole 50 relative to the vehicle (whether left or right). The event that is associated with the wheel that will hit a pothole 50 next is the next event, i.e. at the very bottom in the event queue according to FIG. 12. In a substep S2f, a force requirement in relation to the pothole 50 that is situated lowest in the event queue is transmitted to the corresponding actuator.

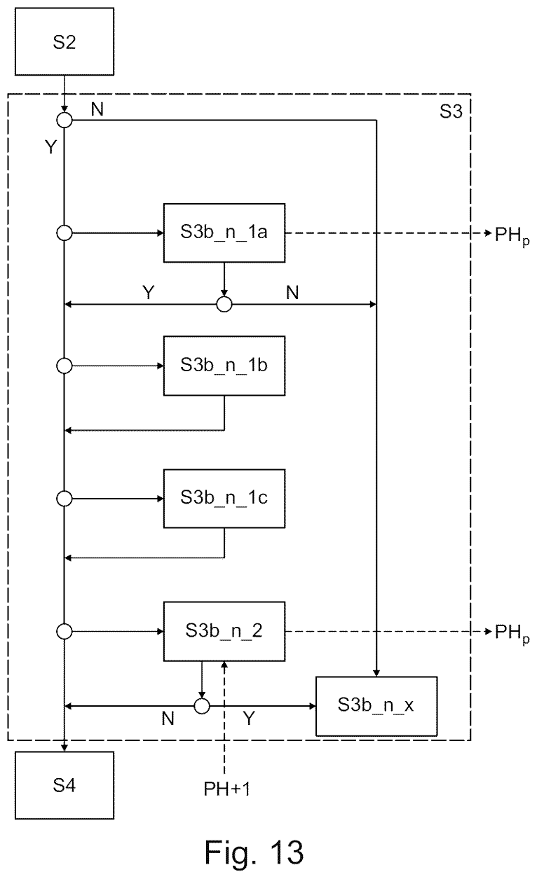

In a third step S3 according to FIG. 13, the event that is situated at the very bottom in the event queue is selected as the next event for which the actuators are to be actuated. In the case of Table 2 in connection with FIG. 8, the right wheel on the front axle would be the wheel that hits the pothole PH2. The first position in the event queue is always associated with potholes detected in the blind mode.

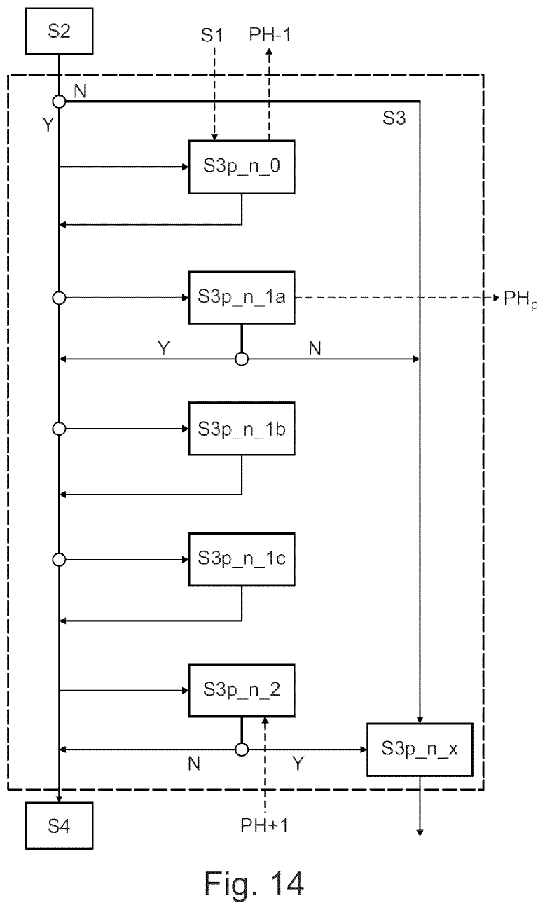

In FIG. 13, the crossing of a pothole in the blind mode is explained in further substeps of the method according to FIG. 9, which relate to the event S3b_n in the event queue. If a pothole is not detected by chassis height sensors on the front axle (N as in no), the event is deleted (S3b_n_x). If a pothole is detected (Y as in yes), the method jumps to substep S3b_n_1a. This step corresponds to phase 1a: verification as to whether a pothole has actually been hit. If not (N), the event is deleted (S3b_n_x). If yes (Y), a controlled lowering to the bottom of the pothole 50 is carried out. The data are shared with a coupled event PHp (pot hole paired), which relates to the same pothole (i.e. for driving over it with the rear axle). If the pothole is not confirmed, this results in deletion of the coupled event. The method jumps to step S3p_n_1b in which the wheel rolls over the bottom of the pothole 50. FIG. 13 does not show a step S3p_n_1c, which is carried out only by using highly accurate maps (geofencing) and a known pothole length, in which the wheel is lifted over the ascending edge of the pothole, similarly to a preview mode (see FIG. 14). In step S3p_n_2, the wheel 10 hits the ascending flank and, again, the flat roadway. Further data are shared with the coupled event (PHp). The data relate to the pothole length, which was precisely determined once the pothole was driven over by a wheel on the front axle.

The wheels on the vehicle are actuated accordingly in order to control the movement of the vehicle. If the vehicle is controlled (Y), the event is deleted in step S3b_n_x. In addition, in step S3p_n_2, a force requirement can be directed to the actuators of the wheel when it is in phase S3p_n_0. Once a pothole has been detected in the blind mode, a preview event is expected (PH+1). This event can request that the vehicle body be lifted while the pothole is still being crossed by a front wheel in the blind mode.

In FIG. 14, the crossing of a pothole in the preview mode is explained in further substeps of the method according to FIG. 9, which relate to the event S3p_n in the event queue. If, at the onset of step S3, a pothole detected by the camera is confirmed by the chassis height sensors on the front axle, the method jumps to step S3p_n_0. This corresponds to the preparatory phase (phase 0 in FIG. 14). If a pothole is not detected by the chassis height sensors on the front axle (N as in No), the event is deleted (S3p_n_x). If the pothole is confirmed by the chassis height sensors on the front axle, the information regarding the distance to the pothole and the length of the pothole is updated in step S3p_n_0. A decision is reached as to whether the pothole is to be flown over or passed through. In step S3p_n_0, information from step S1 is used. Data regarding the preceding pothole (PH−1) are transmitted, which relate, for example, to data regarding force requirements on the actuators, in order to extend the chassis in preparation for the pothole to be hit.

In substep S3p_n_1a, verification as to whether a pothole was actually hit is carried out. If not (N), the event is deleted (S3b_n_x). If yes (Y), the method jumps to substep S3p_n_1b. The data are shared with coupled events (PHp).

In substep S3p_n_1b, a decision is reached as to whether to lift the wheel 10 over the pothole 50 or whether to pass through the pothole 50. If the wheel 10 is to be lifted over the pothole 50, i.e. the calculated flight duration is not longer than 0.12 s, the actuators are set to be harder. The method then jumps to the substep S3p_n_2, which relates to the continued travel on the roadway once the pothole has been overcome.

If the wheel is to pass through the pothole, i.e. the calculated flight duration is longer than a vehicle-dependent characteristic value (e.g. longer than 0.12 s as in Table 1), the actuators are set to be softer and a controlled lowering to the bottom of the pothole 50 is carried out. The pothole is then passed through. To lift over the distal edge 54 onto the roadway, a further substep S3p_n_1c is introduced here. The actuators are adjusted to a hard setting, such that the wheel 10 is lifted over the distal edge 54 onto the roadway.

In substep S3p_n_2, a check is carried out to determine whether the wheel 10 is located on the roadway again. The wheels on the vehicle are actuated accordingly in order to control the movement of the vehicle. If the vehicle is controlled (Y), the event is deleted in the substep S3p_n_x. In addition, in step S3p_n_2, a force requirement for overcoming the next pothole 50 (PH+1) can be directed to the actuators of the wheel when it is in phase S3p_n_0.

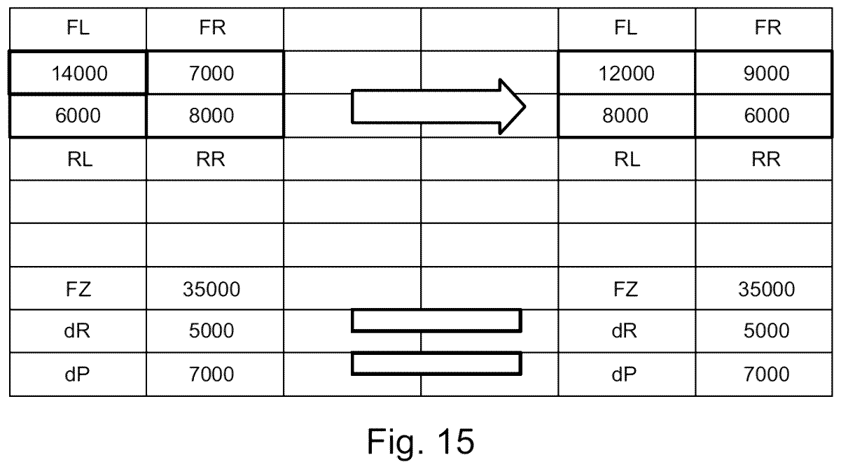

FIG. 15 shows a table with exemplary data for balancing forces. If the force requirement is too high in one corner of the vehicle 1 (left front wheel FL with 14000), which is considerably higher than the others, the force requirements are recalculated for all four corners, such that they are more balanced overall. As is apparent in the lower part of the table, the requirements to lift (Fz), roll (dR), and pitch (dP) the vehicle 1 are maintained.

Power losses and a limitation of available forces of the actuators can bring about undesirable effects, for example, such that the control of lifting, pitching, and rolling of the vehicle 1 would be lost, because the corresponding forces cannot be set. For this purpose, a power manager is introduced, which is provided for the closed-loop control of a corresponding situation. When one or more actuators are restricted in terms of their function, the force requirements in the four corners of the vehicle are brought into equilibrium in order to maintain the control of the vehicle 1 or to hold the balance of the vehicle 1 at least close to the ideal state. This problem is solved by the following formulas:

$$Fztot = {F}_{fl} + {F}_{fr} + {F}_{rl} + {F}_{rr}$$

$$dR = {F}_{fl} - {F}_{fr} + {F}_{rl} - {F}_{rr}$$

$$dP = {F}_{fl} + {F}_{fr} - {F}_{rl} - {F}_{rr}$$

Therein, F_{zTot} is the total force for lifting the vehicle, F_{fl} represents the forces acting on the left front wheel, F_{fr} represents the forces acting on the right front wheel, Fᵣₗ represents the forces acting on the left rear wheel, and Fᵣᵣ represents the forces acting on the right rear wheel. dR is the roll moment and dP is the pitching moment.

For the case in which a corner exceeds its force or power settings, the targeted F_{zTot}, dP, and dR are known, exactly like the (highest possible) forces acting in said corner. Therefore, a system consisting of three equations having three unknowns is present, which can be solved using a matrix.

If the forces are balanced again, further force requirements are checked to determine whether they are below the power and force limitations of the actuators.

When two corners exceed their said limitations at the same time, it is possible to also use the aforementioned approach, wherein an attempt is to be made to work with only two equations, for example, for lifting and rolling. In practical applications it has been shown that all actuators are close to the limit when two actuators exceed their limitation. This problem can be solved in such a way that the force for lifting the vehicle is maintained. For this purpose, the following method loops can be used:

(1) Determine which corners of the vehicle exceed the limit.
(2) Limit the action of force in the corners in which the limit is exceeded, and determine the excessive force.
(3) Redistribute the excessive force to the other corners.
(4) Check that all corners are then below the limitation of power or force.
(5) Repeat the steps (2) through (4) until a uniform distribution of force has been achieved.

### Test Results

Completed tests using the method according to the invention in comparison to vehicles having passive dampers exhibit improvements in comfort. In the tests, potholes having different lengths were passed through (0.3 m, 0.5 m, 0.7 m, 0.9 m, 1.1 m, 1.4 m and 2.0 m). The depth of the potholes was standardized to 10 cm). The performance with potholes having a depth of 0.4 cm and 0.7 cm was checked by means of the ADAMS program, wherein the results show that the vertical acceleration linearly depends on the depth of the corresponding pothole, wherein the performance increases with a gain in comfort as compared to vehicles with passive dampers.

All potholes were crossed at a speed of 30 km/h. As many different time durations as possible for crossing the potholes were measured. At identical time durations, potholes are detected at lower speeds, but greater lengths result in a poorer comfort rating.

For an actuator having a power of 6 kW and a peak force setting of 12 kN, the following values were obtained. Each value was averaged over a range of 7 different potholes. The percentage values relate to the vertical acceleration.
Lifting in the preview mode: 90% improvement,
Passing through in the preview mode: 73% improvement in a range, 67% improvement over all potholes,
Blind mode: 51% improvement.

Similar results were achieved with different actuator sizes.

The simulations for the preview mode were achieved using the CarSim program and, for the blind mode, using the ADAMS program. The programs were selected for the different algorithms because only a single-point tire model is available with CarSim, whereas ADAMS with FTyre is used, in which a total tire model is used, with which more accurate results can be achieved when the tire reaches the distal edge of the pothole. (With the casting model, massive acceleration peaks would result when the tire moves over the pothole edge in one single simulation step). Since, in the preview mode, there is either no impact or only a very slight impact on the ascending edge, the CarSim results are considered indicative of these algorithms. On the other hand, there are no good displays in ADAMS to simulate a camera preview.

The following metric measuring methods are used:

### (1) Scaled Mean Square Error (SMSE):

The Az signal is not evaluated below a value of 1 m/s2 (cut off). The error is calculated as (Az2/number of data points)*scaling+(negative Az peak)2+(positive Az peak)2 and used for results obtained using CarSim.

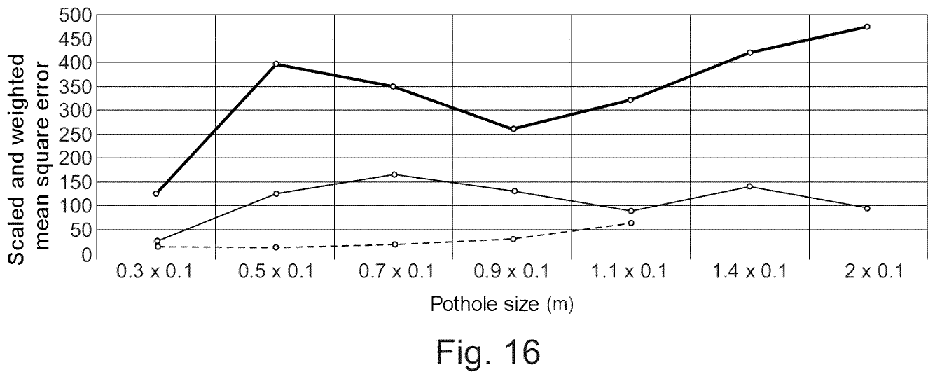

FIG. 16 shows a diagram on the basis of values of a pothole crossing in the preview mode obtained using CarSim & Ford Tyre. The speed was set to 30 km/h. The pothole lengths (in m) are plotted on the x-axis and the vertical acceleration values (SMSE) (in m/s2) are plotted on the y-axis. The actuators were set to maximum values of 6 kW power and 12 kN action of force. The upper graph (thick solid line) relates to values with passive dampers. The middle graph (thin solid line) relates to values for passing through a pothole in the preview mode. The lower graph (dashed line) relates to values for lifting a wheel over a pothole in the preview mode. Particular attention should be given to the relatively smooth transition from lifting to passing through for a pothole length of 1.1 m.

### (2) A Metric Method for Evaluating a Pothole Crossing in the Blind Mode.

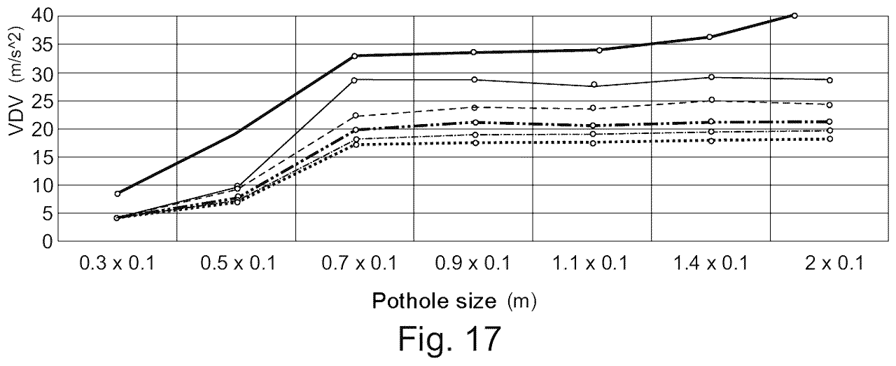

FIG. 17 shows a diagram of values of a pothole crossing in the blind mode obtained using ADAMS & FTyre. The speed was set to 30 km/h. The pothole lengths (in m) are plotted on the x-axis and the vertical acceleration values (VDV) (in m/s2) are plotted on the y-axis. The individual graphs relate to different actuator limitations. The uppermost graph (thick solid line) relates to values with passive dampers. The second graph from the top (thin solid line) relates to values with a damper having maximum value settings of 2 kW and 4 kN. The third graph from the top (dashed line) relates to values with a damper having maximum value settings of 3 kW and 6 kN. The fourth graph from the top (dash—2-dots line) relates to values with a damper having maximum value settings of 4 kW and 8 kN. The fifth graph from the top (dash-dot line) relates to values with a damper having maximum value settings of 5 kW and 10 kN. The lowest graph (dotted line) relates to values with a damper having maximum value settings of 6 kW and 12 kN.

It is shown that the damping correlates with the actuator size (therefore, its strength). The graphs are very flat above a pothole length of 0.7 m. This is due to the fact that the bottom of the pothole was reached at this pothole length in the blind mode.

A pothole of 0.3 m is not actually evaluated as a pothole since, for example, a wheel having a diameter of 0.8 m barely fits therein. However, the value of 0.3 m can be used as a reference point in order to show how the algorithm would react, in order to differentiate false-positive signals from an actual pothole.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A method for controlling at least one force, in an open loop, between wheels and a vehicle body of a vehicle including a front axle and a rear axle when overcoming a roadway depression in a roadway, wherein a suspension means of each of the wheels includes at least one arrangement of a spring system and a vibration damper having at least one actuating member for controlling damper forces in a closed loop, including the steps:
detecting a roadway profile lying ahead in the direction of travel, wherein depressions in the roadway are detected prior to being reached by the vehicle or when reached by the vehicle,
adding a detected depression in the roadway as an event to an event queue,
selecting the depression in the roadway that is the next event in the event queue,
adjusting the suspension means to a suitable setting in order to overcome the depression in the roadway when the detected depression in the roadway has been verified, or
ending the method when the detected depression in the roadway has not been verified.

2. The method according to claim 1, wherein depressions in the roadway are detected prior to being reached by the vehicle via at least one camera on the vehicle or a map, and the depressions in the roadway are detected when reached by the vehicle via chassis height sensors on the vehicle or an artificial neural network.

3. The method according to claim 1, wherein depressions in the roadway are detected in a preview mode of the wheels on the front axle when a camera is available, and in a blind mode of the wheels on the front axle when the camera is not available.

4. The method according to claim 1, wherein events in the event queue are sorted in accordance with a distance from the depression to a relevant wheel.

5. The method according to claim 3, wherein, in the preview mode, a decision is reached depending on a length of the depression in the roadway in a direction of travel and a speed of the vehicle as to whether the wheel that is located ahead of the depression in the roadway will be lifted over the depression in the roadway or will pass through the depression in the roadway, and a crossing is divided into a preview phase, a traversal phase, and a post-traversal phase, wherein the traversal phase is subdivided into a first partial phase and a second partial phase, and in the first partial phase, a depression in the roadway detected by the camera is verified via the chassis height sensor.

6. The method according to claim 3, wherein, in the blind mode, a crossing of the depression in the roadway by the wheels on the front axle is divided into a traversal phase and a post-traversal phase, wherein the traversal phase is subdivided into a first partial phase and a second partial phase, wherein, in the first partial phase, the bottom of the pothole has not yet been reached and a force requirement is sent to the actuators, and in the second partial phase, in which a bottom of the pothole has been reached, the force requirement is cancelled.

7. The method according to claim 1, wherein acting forces are balanced over the actuators in other suspension means when force requirements exceed a capacity of at least one actuator in the suspension means.

8. The method according to claim 2, wherein information regarding a road condition and a dynamic driving state of the vehicle is used in the neural network, and wherein the corresponding dynamic signals are selected from the group including vertical and horizontal acceleration of the wheels over a time curve, accelerations in the corners of the vehicle, longitudinal and lateral acceleration of the vehicle, roll rate normalized by the track width, pitch rate normalized by the wheelbase, height of drop of the wheel, time curve of vertical and horizontal acceleration, torque, braking torque, wheel speed, vehicle speed, height and acceleration of the suspension means in relation to the movement rate of the vehicle body, and an actuator force.

9. The method according to claim 1, wherein a probability of having hit a depression in the roadway is calculated for each wheel on the front axle.

10. The method according to claim 1, wherein, for each wheel on the front axle, a marker is set when a certain probability value of hitting a depression is greater than a threshold value.

11. The method according to claim 10, wherein an effect of the depression is attenuated based on the probability and the marker.

12. The method according to claim 11, wherein the probability initiates an attenuation, and wherein the actuator acts with the greatest possible force in order to retract the wheel until the marker is set.

13. A vehicle for controlling at least one force, in an open loop, between wheels and a vehicle body when overcoming a roadway depression in a roadway, the vehicle including:
a front axle;
a rear axle;
suspension means of each of the wheels including at least one arrangement of a spring system and a vibration damper having at least one actuating member for controlling damper forces in a closed loop; and
a control device configured to perform an open loop control method comprising:
detecting a roadway profile lying ahead in the direction of travel, wherein depressions in the roadway are detected prior to being reached by the vehicle or when reached by the vehicle,
adding a detected depression in the roadway as an event to an event queue,
selecting the depression in the roadway that is the next event in the event queue,
adjusting the suspension means to a suitable setting in order to overcome the depression in the roadway when the detected depression in the roadway has been verified, or
ending the method when the detected depression in the roadway has not been verified.
